(19) United States
(12) Patent Application Publication
(10) Pub. No.: US 2011/0162805 A1
(43) Pub. Date: Jul. 7, 2011

(54) ANGLE ADJUSTING STRUCTURE FOR CARTESIAN ROBOT ARM

(75) Inventor: YUAN-LUNG CHENG, Taipei County (TW)

(73) Assignee: EVERPRECISION TECH CO., LTD., Taipei County (TW)

(21) Appl. No.: 12/857,666

(22) Filed: Aug. 17, 2010

(30) Foreign Application Priority Data
Jan. 7, 2010 (TW) 099200263

(51) Int. Cl. B32B 37/12; B25J 9/12; B25J 18/00

(52) U.S. Cl. 156/578; 74/490.04; 74/490.03; 901/41

(57) ABSTRACT

The present invention discloses an angle adjusting structure for a Cartesian robot arm, comprising an angle adjusting element, a base, and a clamp. A motor transmission unit is disposed on the base, and an upper pulley, a lower pulley and a driving wheel are disposed on the base adjacent to the angle adjusting element. The driving wheel is connected to the motor transmission unit. The upper and lower pulleys clamp the angle adjusting element, and a drive belt is wound around peripheries of the upper pulley and the driving wheel. The clamp is secured to a face of the angle adjusting element opposite to the base, and a glue dispensing needle is disposed at one end of the clamp. The motor transmission unit rotates the driving wheel to drive the drive belt, so that the angle adjusting element is displaced and thus to change a glue dispensing angle.

### FIELD

The present invention relates to an angle adjusting structure, and more particularly to an improved angle adjusting structure for a Cartesian robot arm capable of directly adjusting a glue dispensing angle without disassembling a glue dispensing needle and a clamp.

### BACKGROUND

Industrial glue dispensing techniques are widely applied, such as IC packaging, LCD frame sealing, LED packaging, LED glue potting, or applications on exterior housings of machines. Exemplary applications on housings may be packaging of computer or mobile phone housings, gluing of notebook computers. Additional applications of the glue dispensing apparatuses and techniques may be even in the areas of SMT (surface mount technique) parts, glue dispensing for securing parts before passing through a reflow soldering furnace, the assembly of printed circuit boards, and the like. Glue dispensing acts to protect substrates, microcircuits and ICs from fine dusts, moisture or light, thereby avoiding damage to products.

Operation modes of glue dispensers on the market are divided into two categories: manual operation modes and mechanical operation modes. The glue dispensing process under the manual operation mode must be combined with a precision processing operation, belongs to a labor and cost consuming glue dispensing method. So, mechanical glue dispensing operations have gradually substituted manual operations. In the glue dispensing process under the mechanical operation mode, various parameters are set on a glue dispenser, and a robot arm is used instead of manual glue dispensing. Besides, its technical principles are simple, so it can work alone to perform a glue dispensing operation without additional computer operations and is more accurate and reliable than the conventional manual operation mode.

However, no matter whether a manual operation mode or a mechanical operation mode is used, a situation where it is necessary to adjust a glue dispensing angle cannot be avoided during glue dispensing. When adjusting a glue dispensing angle of most of current glue dispensers, a glue dispensing cylinder and a glue dispensing needle must be disassembled by manual work and then a clamp for clamping the glue dispensing cylinder and the glue dispensing needle is disassembled. After the angle to be adjusted has been determined, the angle of the clamp is adjusted and the clamp is installed. Subsequently, the glue dispensing cylinder and the glue dispensing needle are installed again. Such process is very labor- and time-consuming. More importantly, while reinstalling of the clamp, the glue dispensing cylinder, and the glue dispensing needle is easy to cause a change in the axis of glue dispensing. It is difficult to obtain a correct angle. Therefore, calibration and adjustment must be done repeatedly to find the correct axis and angle.

### SUMMARY

In view of the above-mentioned problems of the prior art, one object of the present invention is to provide an angle adjusting structure for a Cartesian robot arm so as to solve the problems that it is labor- and time- consuming to adjust a glue dispensing angle and many times of calibration must be done to find correct axis and angle between a clamp and a glue dispensing cylinder and a glue dispensing needle.

According to the object of the present invention, there is provided an angle adjusting structure for a Cartesian robot arm comprising an angle adjusting element, a base, and a clamp. The angle adjusting element includes an upper slide rail and a lower slide rail on two faces thereof. A drive belt is disposed on the upper slide rail. On faces of the base adjacent to the angle adjusting element are disposed at least one upper pulley and at least one lower pulley. A motor transmission unit is disposed within the base, and a driving wheel is disposed on the base, adjacent to the upper pulley, and is connected to the motor transmission unit. The upper pulley leans against the upper slide rail, and the lower pulley leans against the lower slide rail. The angle adjusting element is movably clamped between the upper pulley and the lower pulley, and the drive belt is wound around peripheries of the driving wheel and the upper pulley. The clamp is securely screwed to the angle adjusting element, and a glue dispensing needle is disposed at one end of the clamp.

The angle adjusting element further comprises at least one position limiting hole which passes through two sides adjacent to the upper slide rail and the lower slide rail. The clamp is further provided with at least a first through hole on one side of the clamp adjacent to the angle adjusting element. One end of a first fastening element is fitted in the first through hole, and the other end thereof passes through the first through hole and the position limiting hole, leaning against and screwed tightly with a nut, so that the clamp is fastened on the angle adjusting element.

The angle adjusting element is a circular arc metal block of uniform thickness. The clamp is further provided with a clamping piece for fastening a glue dispensing cylinder, and the glue dispensing cylinder is connected with the glue dispensing needle. The glue dispensing cylinder contains adhesive glue that is dispensed on an article to be glue dispensed by the glue dispensing needle.

The motor transmission unit is a servo motor or a step motor.

If it is necessary to adjust a glue dispensing angle during glue dispensing, the motor transmission unit rotates the driving wheel and then the driving wheel drives the drive belt, so that the angle adjusting element is displaced between the upper pulley and the lower pulley and thus the position of the clamp relative to the article to be glue dispensed is changed to change a glue dispensing angle. If the glue dispensing angle is more significantly changed, the clamp may be directly moved and fixedly mounted in an appropriate position limiting hole again.

As described above, the angle adjusting structure for a Cartesian robot arm according to the present invention may have one or more of the following advantages:

(1) According to the angle adjusting structure for a Cartesian robot arm, the motor can rotate the driving wheel and thus drive the drive belt, so that the angle adjusting element is displaced between the upper and lower pulleys and thus the position of the clamp on the angle adjusting element relative to the article to be glue dispensed is changed to achieve the purpose of adjusting a glue dispensing angle and to significantly enhance convenience in use.

(2) According to the angle adjusting structure for a Cartesian robot arm, when the glue dispensing angle needs to be significantly adjusted, it is unnecessary to disassemble the glue dispensing cylinder and the glue dispensing needle. It only requires to simply disassemble the clamp and install the clamp to an appropriate position limiting hole again, so that the glue dispensing operation can be performed again. This can avoid the problem that the calibration must be done repeatedly because the axis and angle between the clamp and the glue dispensing cylinder and the glue dispensing needle may be changed when adjusting the glue dispensing angle.

(3) The angle adjusting structure for a Cartesian robot arm provides enhanced convenience in adjusting the glue dispensing angle, and therefore, the production labor and cost of a glue dispensing plant can be further reduced.

(4) According to the angle adjusting structure for a Cartesian robot arm, when adjusting the angle, the displacement distance of the tip of the glue dispensing needle can be controlled to the minimum level without wasting the workable area of the Cartesian robot arm.

With these and other objects, advantages, and features of the invention that may become hereinafter apparent, the nature of the invention may be more clearly understood by reference to the detailed description of the invention, the embodiments and to the several drawings herein

### BRIEF DESCRIPTION OF THE DRAWINGS

The exemplary embodiment of the present invention will be understood more fully from the detailed description given below and from the accompanying drawings of various embodiments of the invention, which, however, should not be taken to limit the invention to the specific embodiment, but are for explanation and understanding only.

FIG. 1 is a front three-dimensional view of an angle adjusting structure for a

Cartesian robot arm according to the present invention;

FIG. 2 is a rear three-dimensional view of an angle adjusting structure for a

Cartesian robot arm according to the present invention;

FIG. 3 is a schematic view showing the action of an angle adjusting element of an angle adjusting structure for a Cartesian robot arm according to the present invention; and

FIG. 4 is a schematic view showing the action of adjusting a glue dispensing angle by an angle adjusting structure for a Cartesian robot arm according to the present invention.

### DETAILED DESCRIPTION

Embodiments of the angle adjusting structure for a Cartesian robot arm according to the present invention will be described below with reference to the related drawings. For the convenience of understanding the description, the same elements in the embodiments will be given the same reference numerals.

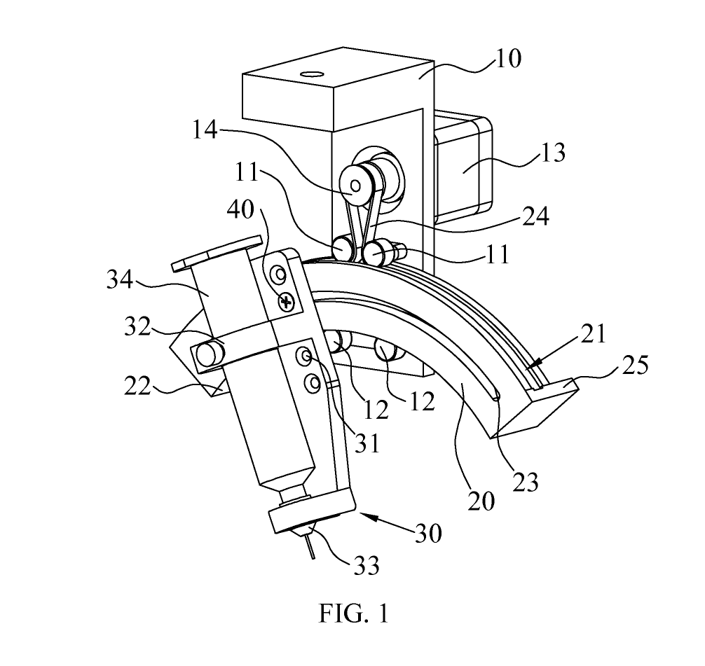

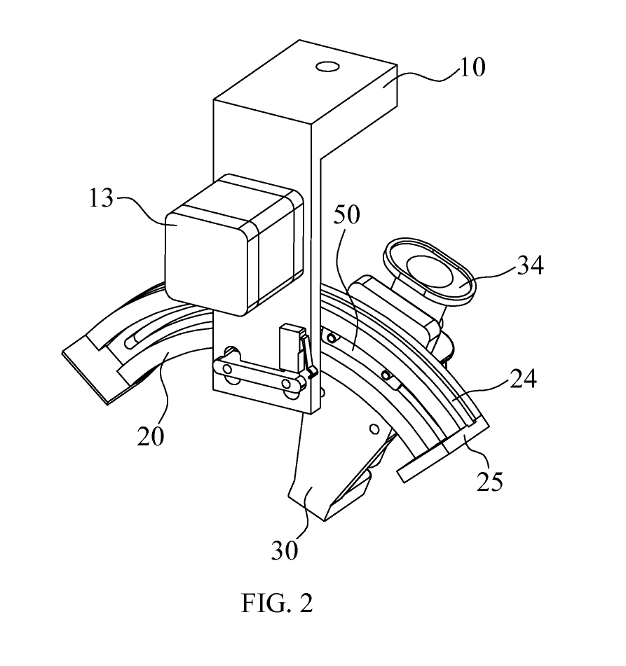

Referring to FIGS. 1 and 2, there are shown front and rear three-dimensional views of an angle adjusting structure for a Cartesian robot arm according to the present invention. In these figures, a motor transmission unit 13 is disposed within a base 10, and at least one upper pulley 11, at least one lower pulley 12, and a driving wheel 14 are disposed on a face of the base 10. The driving wheel 14 is connected to the motor transmission unit 13. An angle adjusting element 20 is clamped between the upper pulley 11 and the lower pulley 12. On the face other than the face of the angle adjusting element 20 adjacent to the base 10 is further provided a clamp 30.

An upper slide rail 21 is provided on one face of the angle adjusting element 20 with respect to the upper pulley 11, and a lower slide rail 22 is provided on the other face thereof with respect to the lower pulley 12. A drive belt 24 is disposed on the upper slide rail 21 and wound around peripheries of the driving wheel 14 and the upper pulley 11 Limiting bodies 25 are provided at both ends of the angle adjusting element 20. Both ends of the drive belt 24 are fastened on the limiting bodies 25. At least one position limiting hole 23 is provided on the two sides adjacent to the upper slide rail 21 and the lower slide rail 22.

The clamp 30 is provided with at least a first through hole 31 corresponding to the position limiting hole 23 on one side of the clamp 30 adjacent to the angle adjusting element 20. One end of a first fastening element 40 is fitted in the first through hole 31, and the other end thereof passes through the first through hole and the position limiting hole, protrudes out of the position limiting hole 23, leans against and screwed tightly with a nut 50, so that the clamp 30 is fastened on the angle adjusting element 20.

The clamp 30 is provided at one end thereof with a clamping piece 32, and a glue dispensing needle 33 is further disposed at the other end thereof. The clamping piece 32 can fasten a glue dispensing cylinder 34, and the glue dispensing cylinder 34 is connected with the glue dispensing needle 33. The glue dispensing cylinder 34 contains adhesive glue that is dispensed on an article to be glue dispensed by the glue dispensing needle 33.

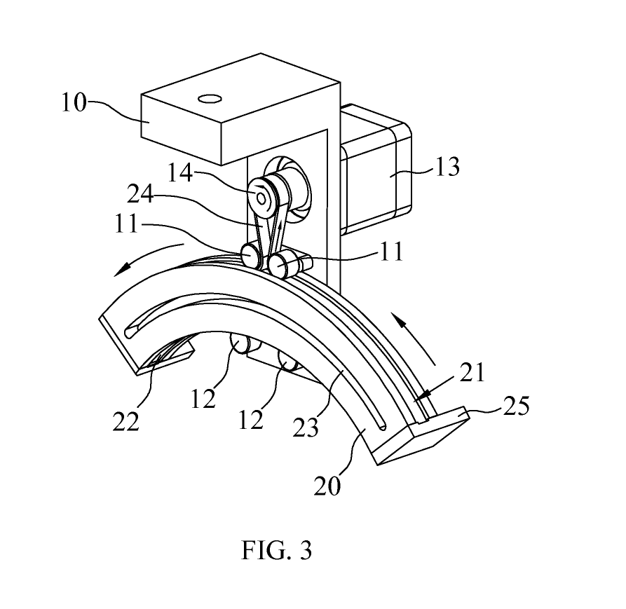

Referring to FIG. 3, there is shown a schematic view showing the action of an angle adjusting element of an angle adjusting structure for a Cartesian robot arm according to the present invention. The upper pulley 11 leans against the upper slide rail 21 and the lower pulley 12 leans against the lower slide rail 22, so that the angle adjusting element 20 is clamped between the upper pulley 11 and the lower pulley 12. When the motor transmission unit 13 rotates the driving wheel 14, the driving wheel 14 drives the drive belt 24 so that the angle adjusting element 20 slides along and between the upper pulley 11 and the lower pulley 12. When the driving wheel 14 rotates counterclockwise, the drive belt 24 drives the angle adjusting element 20 to displace counterclockwise. The limiting bodies 25 limits the maximum displacement range of the angle adjusting element 20, so that the angle adjusting element 20 does not slide away from the intermediate space between the upper pulley 11 and the lower pulley 12 when adjusting the angle.

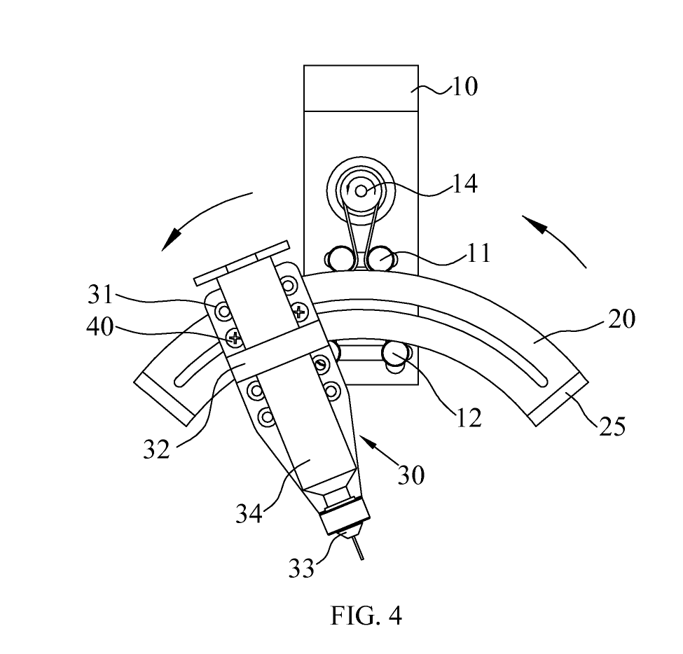

Referring to FIG. 4, there is shown a schematic view showing the action of adjusting a glue dispensing angle by an angle adjusting structure for a Cartesian robot arm according to the present invention. The clamp 30 is securely screwed to the angle adjusting element 20. And a glue dispensing needle is disposed at one end of the clamp. If it is necessary to adjust a glue dispensing angle during a glue dispensing process, the motor transmission unit 13 rotates the driving wheel 14 and thus drives the drive belt 24, so that the angle adjusting element 20 slides between the upper pulley 11 and the lower pulley 12 and thus rotates the clamp 30 accordingly. At the same time, the glue dispensing needle 33 is also driven along with the clamp 30 to change the position of the glue dispensing needle 33 relative to the article to be glue dispensed, whereby the glue dispensing angle can be adjusted. If the glue dispensing angle is more significantly changed, the first fastening element 40 is screwed off and the clamp 30 is directly moved to an appropriate position. Then, the first fastening element 40 and the clamp 30 are securely screwed to the position limiting hole 23 corresponding to the appropriate position again, thereby achieving the purpose of adjusting a glue dispensing angle.

The above description is illustrative only and is not to be considered limiting. Various modifications or changes can be made without departing from the spirit and scope of the invention. All such equivalent modifications and changes shall be included within the scope of the appended claims.

What is claimed is:

1. An angle adjusting structure for a Cartesian robot arm, comprising:
an angle adjusting element, comprising:
an upper slide rail disposed on one face thereof;
a lower slide rail disposed on another face thereof opposite to the upper slide rail; and
a drive belt disposed on the upper slide rail;
a base adjacent to the angle adjusting element, comprising:
at least one upper pulley disposed on a face of the base and leaning against the upper slide rail;
at least one lower pulley adjacent to the upper pulley and leaning against the lower slide rail, so that the angle adjusting element is movably clamped between the upper pulley and the lower pulley;
a driving wheel adjacent to the upper pulley, the drive belt being wound around peripheries of the driving wheel and the upper pulley; and
a motor transmission unit connected to the driving wheel and rotating the driving wheel; and
a clamp securely screwed to a face of the angle adjusting element opposite to the base, wherein the motor transmission unit rotates the driving wheel, so that the drive belt drives the angle adjusting element to slide between the upper pulley and the lower pulley to change an angle of the clamp.

2. The angle adjusting structure for a Cartesian robot arm as recited in claim 1, wherein the angle adjusting element is further provided with at least one position limiting hole which passes through two sides adjacent to the upper slide rail and the lower slide rail.

3. The angle adjusting structure for a Cartesian robot arm as recited in claim 2, wherein a glue dispensing needle is disposed at one end of the clamp, and the clamp is provided with at least a first through hole corresponding to the position limiting hole on one side of the clamp adjacent to the angle adjusting element.

4. The angle adjusting structure for a Cartesian robot arm as recited in claim 3, further comprising at least a first fastening element, one end of the first fastening element being fitted in the first through hole, and another end of the first fastening element passing through the first through hole and the position limiting hole, leaning against and being screwed tightly with a nut, so that the clamp is fastened on the angle adjusting element.

5. The angle adjusting structure for a Cartesian robot arm as recited in claim 3, wherein the clamp is further provided with a clamping piece for fastening a glue dispensing cylinder, and the glue dispensing cylinder is connected with the glue dispensing needle, and the glue dispensing cylinder contains adhesive glue that is dispensed on an article to be glue dispensed by the glue dispensing needle.

6. The angle adjusting structure for a Cartesian robot arm as recited in claim 1, wherein the angle adjusting element is a circular arc metal block of uniform thickness.

7. The angle adjusting structure for a Cartesian robot arm as recited in claim 1, wherein two limiting bodies are provided at both ends of the angle adjusting element, respectively, and both ends of the drive belt are fixedly mounted on the limiting bodies.

8. The angle adjusting structure for a Cartesian robot arm as recited in claim 1, wherein the motor transmission unit is a servo motor or a step motor.
